(19) United States
(12) Patent Application Publication
(10) Pub. No.: US 2018/0077755 A1
(43) Pub. Date: Mar. 15, 2018

(54) HEATING ELEMENT, METHOD OF MANUFACTURING THE SAME, AND APPARATUS INCLUDING THE SAME

(71) Applicant: SAMSUNG ELECTRONICS CO., LTD., Suwon-si (KR)

(72) Inventors: Seyun KIM, Seoul (KR); Haengdeog KOH, Hwaseong-si (KR); Doyoon KIM, Hwaseong-si (KR); Jinhong KIM, Seoul (KR); Hajin KIM, Hwaseong-si (KR); Soichiro MIZUSAKI, Suwon-si (KR); Minjong BAE, Yongin-si (KR); Hiesang SOHN, Seoul (KR); Changsoo LEE, Seoul (KR)

(21) Appl. No.: 15/680,830

(22) Filed: Aug. 18, 2017

(30) Foreign Application Priority Data
Sep. 12, 2016 (KR) 10-2016-0117369

(51) Int. Cl. H05B 3/12; H05B 3/14; H05B 3/26

(52) U.S. Cl. CPC H05B 3/12; H05B 3/141; H05B 3/146; H05B 2203/013; H05B 3/26; H05B 2203/017; H05B 3/148

(57) ABSTRACT

A heating element includes a matrix; and a plurality of conductive fillers, wherein some of the plurality of conductive fillers include first nano-sheets and first metal media configured to reduce a contact resistance between the first nano-sheets.

### CROSS-REFERENCE TO RELATED APPLICATIONS

This application claims priority to and the benefit of Korean Patent Application No. 10-2016-0117369, filed on Sep. 12, 2016, in the Korean Intellectual Property Office, and all the benefits accruing therefrom under 35 U.S.C. § 119, the content of which is incorporated herein by reference in its entirety.

### BACKGROUND

### 1. Field

The present disclosure relates to a heating element, and more particularly, to a heating element, a method of manufacturing the heating element, and an apparatus including the heating element.

### 2. Description of the Related Art

Heating elements may be largely classified into organic heating elements, metal heating elements, and ceramic heating elements. The organic heating element may include a carbon source as a primary component, for example a carbon source such as graphite, carbon nano-tube, or carbon black. The metal heating element may include a metal such as Ag, a Ni—Cr based ally, Mo, and W. The ceramic heating element may include a ceramic material such as silicon carbide, and molybdenum silicide.

Heating elements may be further classified into a rod type heating element having a rod shape, and a sheet type heating element having the form of a thick film on a substrate.

The organic heating element may be easily and inexpensively manufactured, but the high temperature durability thereof is relatively low since the organic material reacts with oxygen at elevated temperatures.

The metal heating element may have excellent electrical conductivity and may be easily controlled, and thus, the metal heating element has good heat generating characteristics. However, the metal may be oxidized at elevated temperatures, and accordingly, the heat generating characteristics of the metal heating element may be reduced.

The ceramic heating element may have relatively low reactivity with oxygen, and thus, at elevated temperatures, the durability of the ceramic heating element may be excellent. However, the electrical conductivity of the ceramic heating element may be relatively low in comparison with the metal heating element. Also, the ceramic material may be sintered at elevated temperatures.

The rod type heating element may be easily manufactured, but maintaining a uniform temperature in the cavities of the rod type heating element may be difficult. In contrast, since the sheet type heating element generates heat from its entire surface, a temperature in cavities thereof may be uniformly maintained. Thus there remains a need for an improved heating element.

### SUMMARY

Provided is a heating element including a conductive filler, in which the contact resistance of the conductive filler is reduced.

Provided is a method of manufacturing the heating element which is capable of reducing a sintering temperature and enhancing the processability of the heating element.

Provided is an apparatus including the heating element and which is capable of enhancing a heating efficiency of the heating element.

According to an aspect, a heating element may include: a matrix; and a conductive filler, wherein the conductive filler includes a first nano-sheet and a first metal medium configured to reduce a contact resistance of the first nano-sheet.

In the heating element, the conductive filler may further include a second nano-sheet and a second metal medium configured to reduce a contact resistance of the second nano-sheet.

The first nano-sheet and the second nano-sheet may be same as or different from each other, and the first metal medium and the second metal medium may be the same as or different from each other.

The first nano-sheet may include at least one nano-sheet selected from an oxide nano-sheet, a boride nano-sheet, a carbide nano-sheet, and a chalcogenide nano-sheet, and the second nano-sheet may be the same as or different from the first nano-sheet.

The first metal medium may be a first metal particle including at least one selected from a noble metal, a transition metal, and a rare earth metal, and the second metal medium may include a second metal particle which is the same as or different from the first metal particle.

A diameter of the first metal particle and a diameter of the second metal particle independently may be about 1 nanometer (nm) to about 10 micrometers (m).

The conductive filler may further include a second nano-sheet which is different from the first nano-sheet.

The matrix and the conductive filler may be mixed to form a layer, and an amount of the conductive filler may be less than an amount of the matrix in the layer.

The matrix and the conductive filler may be mixed to form a layer, and an amount of the conductive filler in the layer may be equal to or greater than about 0.1 volume percent (vol %) and less than about 100 vol %, based on a total volume of the layer.

The conductive filler may be distributed from an end of the layer to another end of the layer and is configured to form an electrical path through the layer.

The layer is disposed on the substrate and the substrate is an insulating substrate.

In another example embodiment, the layer may be disposed on the substrate, the substrate may be a conductive substrate, and an insulating layer may be between the substrate and the layer.

A portion of the electrical path may include the first nano-sheet and the first metal medium.

Another portion of the electrical path may include the first nano-sheet, a second nano-sheet, or the second nano-sheet and a second metal medium, which is in contact with the second nano-sheet and is configured to reduce a contact resistance of the second nano-sheet.

The first nano-sheet and the second nano-sheet may be same as or different from each other.

The first metal medium and the second metal medium may be same as or different from each other.

The heating element may have a pellet shape or a film shape.

The first metal medium may be in contact with at least one surface of the first nano-sheet.

The first nano-sheet may include one oxide nano-sheet, or two oxide nano-sheets which are different from each other.

The matrix may include glass frit or an organic material.

The glass frit may include at least selected from silicon oxide, lithium oxide, nickel oxide, cobalt oxide, boron oxide, potassium oxide, aluminum oxide, titanium oxide, manganese oxide, copper oxide, zirconium oxide, phosphorus oxide, zinc oxide, bismuth oxide, lead oxide, and sodium oxide.

The glass frit may include silicon oxide and an additive, and the additive may include at least one selected from Li, Ni, Co, B, K, Al, Ti, Mn, Cu, Zr, P, Zn, Bi, Pb, and Na.

The organic material may include at least one selected from polyimide (PI), polyphenylene sulfide (PPS), polybutylene terephthalate (PBT), polyamideimide (PAI), liquid crystalline polymer (LCP), polyethylene terephthalate (PET), and polyetheretherketone (PEEK).

According to another aspect, a method of manufacturing a heating element includes: mixing including a conductive filler and a matrix to form a mixture; forming a product having a predetermined shape from the mixture; and heat treating the product to provide the heating element, wherein the conductive filler includes a first nano-sheet and a first metal, and wherein the first metal is in contact with the first nano-sheet.

In the method of manufacturing the heating element, the forming the product may include coating a substrate with the mixture and drying the coating on the substrate.

The substrate may be selected from a substrate having a same composition as the matrix, a substrate having a different composition from the matrix, a silicon substrate, and a metal substrate.

The coating of the substrate may include at least one selected from a screen printing method, an ink jet method, a dip coating method, a spin coating method, or a spray coating method.

The matrix may include glass frit.

According to an aspect of an exemplary embodiment, an apparatus includes a heating element as described above.

The apparatus may further include at least one selected from an adiabatic member and a thermal reflection member, disposed on a side of the heating element.

The heating element may be configured to supply heat to a region inside the apparatus.

The heating element may be disposed to supply heat to a region on an outside of the apparatus.

Additional aspects will be set forth in part in the description which follows and, in part, will be apparent from the description, or may be learned by practice of the presented exemplary embodiments.

### BRIEF DESCRIPTION OF THE DRAWINGS

These and/or other aspects will become apparent and more readily appreciated from the following description of the example embodiments, taken in conjunction with the accompanying drawings in which:

FIG. 1 is a cross-sectional view of an embodiment of a heating element;

FIG. 2 is an enlarged perspective view of an embodiment of the conductive filler in FIG. 1;

FIG. 3 is a cross-sectional view of an embodiment wherein an insulating layer is between a substrate and the heating element in FIG. 1;

FIG. 4 is a three-dimensional view of an embodiment of a heating element having a cylindrical shape;

FIG. 5 is a flowchart of an embodiment of a method of manufacturing a heating element;

FIG. 6 is a scanning electron microscope (SEM) photograph of an embodiment of an exfoliated RuO₍₂₊ₓ₎ nano-sheet, where 0≦x≦0.1, used in the method of manufacturing a heating element;

FIG. 7A is an SEM photograph of an embodiment of a filler formed in a process of manufacturing a heating element;

FIG. 7B is an enlarged view of the region A1 in the SEM photograph in FIG. 7A.

FIG. 7C is an enlarged view of the region A2 in the SEM photograph in FIG. 7A.

FIGS. 8A and 8B are SEM photographs of a cross-section of an embodiment of a heating element formed in a process of manufacturing a heating element;

FIG. 9 is a cross-sectional view of an embodiment of an apparatus including a heating element;

FIG. 10 is an enlarged cross-sectional view of a portion of the apparatus shown in FIG. 9;

FIG. 11A is an embodiment of an apparatus including another embodiment of a heating element; and

FIG. 11B is an embodiment of an apparatus including yet another embodiment of a heating element.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the context clearly indicates otherwise. “At least one” is not to be construed as limiting to “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “nanomaterial” refers to a material having a least one dimension (e.g., a diameter or a thickness) which is on a nanoscale, i.e., a dimension of less than about 1000 nanometers (nm), or about 1 nm to about 1000 nm.

As used herein, the term “nano-rod” refers to a material having a cylindrical shape and which has at least one dimension (e.g., a diameter) in a range of less than about 1000 nanometers (nm), or about 1 nm to about 1000 nm, and has an aspect ratio of 3 to 5.

As used herein, the term “nano-sheet” refers to a material having a two-dimensional structure in the form of a sheet and which has a thickness of less than about 1000 nanometers (nm), or a thickness in a range of about 1 nm to about 1000 nm.

When a sheet type heating element, i.e., a heating element in the form of a sheet, is manufactured, a glass frit that forms a matrix material and a filler that may generate heat are mixed together to form a composite. In this case, the individual filler particles are connected to each other in order to be electrified, and thus, heat may be generated. When a heating element uses a ceramic material as filler, in the related art, the filler particles may have a shape in the form of a sphere or a three dimensional polyhedral structure. For example, and while not wanting to be bound by theory, it is understood that RuO₂ particles having a spherical or polyhedral shape may be used as filler. When these types of RuO₂ particles are used, it is understood that theoretically percolation between RuO₂ particles may be possible when an entire surface of glass frit particles are covered by the RuO₂ particles, and thus, stable heat generation may be provided.

However, when the RuO₂ particles having a spherical or a polyhedral shape are used as a filler, a contact area between the RuO₂ particles is small, and thus, a high temperature may be used to effect sintering, and the amount of RuO₂ particles to be percolated in the matrix material may be increased.

In the heating element of the present disclosure, at least some of the filler may include metal particles and nano-sheets, which is a type of nano-material. Thus, a percolation network may be more easily established in the heating element of the present disclosure in comparison with a filler which does not include nano-sheets. In addition, conductivity may be improved, sinterability may be enhanced, and a sintering temperature may be lowered for the heating element of the present disclosure in comparison with a filler which does not include nano-sheets. In addition, when the filler without nanosheets and the conductive filler of the disclosure are used in the same amounts, an electrical conductivity may be greater in the heating element of the present disclosure in comparison with a heating element including a filler which does not include nano-sheets.

Hereinafter, a heating element, a method of manufacturing the same, and an apparatus including the same will be described in further detail with reference to the accompany drawings. In the drawings, thicknesses of regions and layers may be exaggerated for the sake of clarify.

### 1. Heating Element

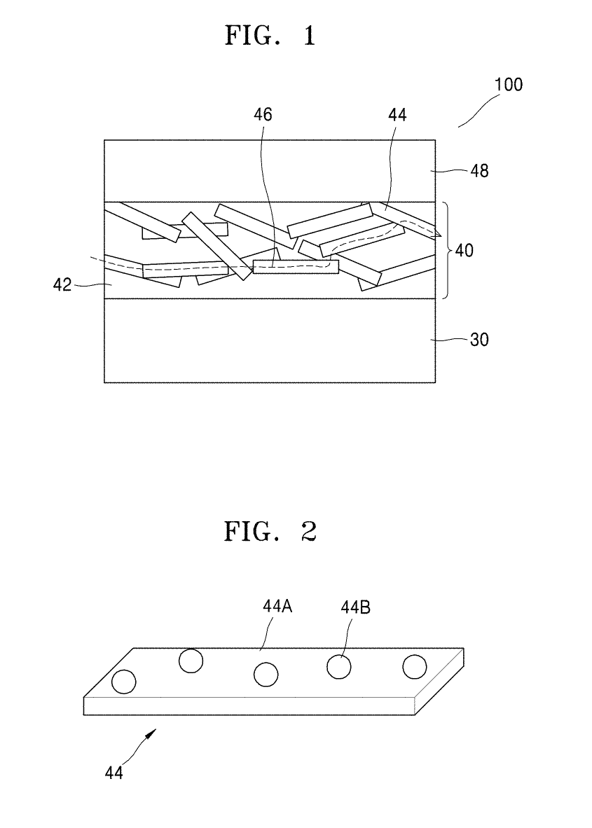

As shown in FIG. 1, the heating element 100 comprises a heating layer 40, which comprises a material that generates heat when external energy is applied thereto. The energy may be electrical energy, but any type of energy that may make the heating layer 40 generate heat may be used. The heating element may comprise a substrate 30 disposed on the heating layer. The substrate 30 may include a single layer or a plurality of layers. The heating layer 40 comprises a matrix 42 and a plurality of conductive fillers 44. In an example, the heating layer 40 may include the matrix 42 and the plurality of conductive fillers 44. In another example, the heating layer 40 may further include other components in addition to the matrix 42 and the plurality of conductive fillers 44. The heating layer 40 may have a structure wherein the plurality of conductive filler 44 are distributed or diffused in the matrix 42. The plurality of conductive filler 44 may be uniformly distributed or diffused throughout the entire heating layer 40. The matrix 42 and the plurality of conductive fillers 44 may be combined (e.g. mixed) to form a single layer. The heating element may further comprise a top side layer 48, and the top side layer 48 may be disposed on the heating layer opposite the substrate 30. The top side layer 48 may include a single layer or a plurality of layers. An embodiment in which the heating element comprises the substrate 30, the heating layer 40, and the top side layer 48 is mentioned.

In FIG. 1, the plurality of conductive fillers 44 are illustrated as having the same lengths and shapes throughout, but the length and the shape of the plurality of conductive fillers 44 may be different from each other. The conductive fillers 44 may be exposed on side surfaces at each end of the heating layer 40. In other words, the side surface of the first end of the heating layer 40 may include the matrix 42 and the conductive fillers 44, and a same structure may be on the side surface of the second end of the heating layer 40. The first side surface and the second side surface of the heating layer 40 may be in contact with a power supply when the heating layer 40 is connected to the power supply. The plurality of conductive filler 44 may be exposed at a location where the heating layer 40 is connected to the power supply, even though the location may not be on the first end or the second end.

As illustrated in FIG. 2, the conductive fillers 44 may include a nano-sheet 44A and a metal particle 44B. The metal particle 44B may be an example of a metal medium. The metal particle 44B may be on a top surface and/or a bottom surface of the nano-sheet 44A. In FIG. 2, the metal particle 44B is illustrated as being only on the top surface of the nano-sheet 44A for the sake of convenience. The metal particle 44B may be in direct contact with the nano-sheet 44A. For example, the metal particle 44B may be adhered to the nano-sheet 44A.

Referring to FIGS. 1 and 2, adjacent nano-sheets 44A of the plurality of conductive fillers 44 may be in contact with each other. An indirect contact between adjacent nano-sheets 44A may be realized via the metal particle 44B. That is, two adjacent nano-sheets 44A may be in contact with each other via the metal particle 44B therebetween as a medium. In this case, the metal particle 44B may be a metal particle on any one of two adjacent nano-sheets 44A. Indirect contact between adjacent nano-sheets 44A may occur at any location throughout the conductive filler 44. Accordingly, a conductive path 46 or an electrical current flow path may be formed between the first end and the second end of the heating element layer 40. In FIG. 1, only one conductive path 46 is illustrated, but more than one conductive path may be formed.

Direct contact between adjacent nano-sheets 44A of the plurality of conductive fillers 44 may also be possible. In other words, adjacent nano-sheets 44A may be in a direct contact with each other, without using the metal particle 44B as the medium. Direct contact between adjacent nano-sheets 44A may occur in one or more sections of the conductive path 46.

Since adjacent nano-sheets 44A of the conductive filler 44 are in contact with each other via the metal particle 44B as the medium (i.e., indirectly contact), a contact resistance between the nano-sheets 44A may be less than when the nano-sheets 44A are in direct contact with each other without the metal particle 44B therebetween. Thus, as previously presented, the metal particle 44B may be used as a medium or as a method for reducing the contact resistance between the nano-sheets 44A. Since the metal particle 44B exists between the nano-sheets 44A, when compared to a same amount of conductive filler without the nano-sheets, the electrical conductivity of the heating layer 40 including the plurality of conductive fillers 44 may be much greater. In addition, the electrical conductivity of the heating layer 40 may be greater than that of a heating element which includes the conductive fillers including only the nano-sheets.

As a result, heating characteristics (for example, a heating efficiency) of the heating layer 40 may be more improved as compared to a heating element which includes only the metal particles or only the nano-sheets as a conductive filler. Accordingly, in the case of an apparatus including the heating layer 40, the heating characteristics or operational characteristics of the apparatus may also be improved.

The nano-sheets 44A in the plurality of conductive fillers 44 in the heating layer 40 may include an identical material and the metal particles 44B may also include an identical metal.

In another embodiment, some (hereinafter, first conductive fillers) of the plurality of conductive fillers 44 may include first nano-sheets and first metal particles, and others (hereinafter, second conductive fillers) may include second nano-sheets and second metal particles. The first metal particles may be in contact with the first nano-sheets and be one of the first metal media for reducing the contact resistance between adjacent first nano-sheets. The second metal particles may be in contact with the second nano-sheets and be one of the second media for reducing the contact resistance between the second nano-sheets.

In another embodiment, the first conductive filler may include the first nano-sheets and the first metal particles, and the second conductive filler may include only the second nano-sheets, or vice versa. The first and second nano-sheets may be nano-sheets of an identical material or may be materials which are different from each other. The first and second metal particles may include the same metal or may be metals which are different from each other. At least one of the first nano-sheets and the second nano-sheets may be the nano-sheet 44A in FIG. 2. At least one of the first metal particles and the second metal particles may be the metal particle 44B in FIG. 2.

The heating layer 40 in FIG. 1 may be formed on the substrate 30. That is, the heating layer 40 in FIG. 1 may provide a sheet type heating element wherein the heating layer is formed on a surface of the substrate 30. The surface of the substrate 30 may be, for example, the top surface of the substrate 30.

As illustrated in FIG. 4, a heating element may be in a form of a cylinder 50 having a cylindrical shape. The cylindrical heating element 50, e.g., having a pellet shape, may be formed by using a mold. A composition of the cylindrical heating element 50 having the pellet shape may be the same as that of the heating layer 40, which is shown in FIG. 1.

In the aforementioned embodiment, the matrix 42 may comprise, for example, at least one selected from a glass frit, and an organic material. The glass frit may include at least one oxide selected from silicon oxide, lithium oxide, nickel oxide, cobalt oxide, boron oxide, potassium oxide, aluminum oxide, titanium oxide, manganese oxide, copper oxide, zirconium oxide, phosphorus oxide, zinc oxide, bismuth oxide, lead oxide, and sodium oxide.

The organic material may include an organic polymer. For example, the organic material may include at least one polymer selected from polyimide (PI), polyphenylenesulfide (PPS), polybutylene terephthalate (PBT), polyamideimide (PAI), liquid crystalline polymer (LCP), polyethylene terephthalate (PET), polyphenylene sulfide (PPS), and polyetheretherketone (PEEK).

In another example embodiment, the glass frit may include silicon oxide having an additive added thereto, and the additive may include at least one selected from Li, Ni, Co, B, K, Al, Ti, Mn, Cu, Zr, P, Zn, Bi, Pb, and Na.

According to an embodiment, the substrate 30 may be an insulating substrate. The substrate 30 may be a substrate having the same composition as or a different composition from that of the matrix 42. For example, the substrate 30 may include at least one oxide selected from silicon oxide, lithium oxide, nickel oxide, cobalt oxide, boron oxide, potassium oxide, aluminum oxide, titanium oxide, manganese oxide, copper oxide, zirconium oxide, phosphorus oxide, zinc oxide, bismuth oxide, lead oxide, and sodium oxide. In this case, an oxide used for forming the substrate 30 may be the same as or different from the oxide used for forming the matrix 42. Alternatively, the substrate 30 may be a substrate including an oxide which is not used for forming the matrix 42.

According to another embodiment, the substrate 30 may not include an oxide but instead may be a substrate including a material which is different from that used to form the matrix 42. For example, the substrate 30 may be a silicon substrate (e.g., a silicon wafer) or a metal substrate.

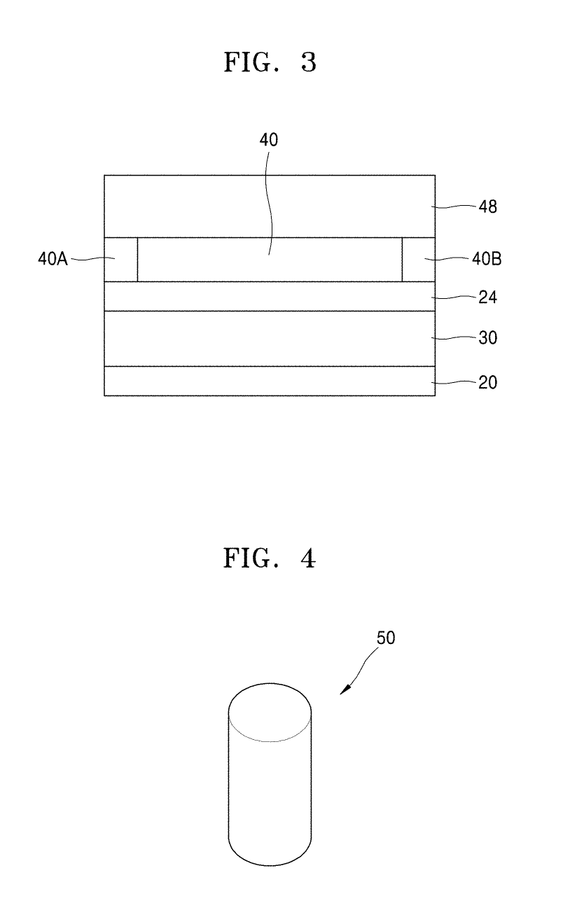

When the substrate 30 is a conductive substrate, an insulating layer 24 may be disposed between the substrate 30 and the heating layer 40, as illustrated in FIG. 3. Also, an additional insulating layer 20 may be under the substrate 30. The insulating layers 20 and 24 may be, for example, enamel. A first electrode 40A and a second electrode 40B may be respectively on both ends of the heating layer 40. The first and second electrodes 40A and 40B may be adhered to the both ends of the heating layer 40. Electrical power may be supplied from the power supply to the heating layer 40 via the first and second electrodes 40A and 40B. The entire structure illustrated in FIG. 3 may be denoted as a heating element.

The nano-sheet 44A included in the conductive filler 44 may have a composition having a certain predetermined electrical conductivity. For example, the nano-sheet 44A may have an electrical conductivity of at least about 1,250 Siemens per meter (S/m). The electrical conductivity of the nano-sheet 44A may be less or greater than a certain electrical conductivity, depending on the case. The first and second nano-sheets may also have a composition having the certain electrical conductivity.

In an embodiment, the nano-sheet 44A of the conductive filler may have an electrical conductivity of at least about 1,250 S/m, or at least about 5,000 S/m, or at least about 10,000 S/m, or at least about 20,000 S/m, or about 1,250 S/m to about 20,000 S/m, about 2,000 S/m to about 10,000 S/m.

The nano-sheet 44A, the first nano-sheets, and the second nano-sheets may independently have the above-described conductivity, and may respectively include at least one oxide nano-sheet selected from an oxide nano-sheet, a boride nano-sheet, a carbide nano-sheet, and a chalcogenide nano-sheet.

The nano-sheet 44A, the first nano-sheets, and the second nano-sheets may respectively include one oxide nano-sheet or two oxide nano-sheets which are different from each other.

The oxide nano-sheet may include, for example, at least one selected from RuO₍₂₊ₓ₎ (0≦X≦0.1), MnO₂, ReO₂, VO₂, OsO₂, TaO₂, IrO₂, NbO₂, WO₂, GaO₂, MoO₂, InO₂, CrO₂, and RhO₂. The aforementioned oxide nano-sheets may have the respective conductivities as shown in Table 1

TABLE 1
Oxide nano-sheet conductivity

| Composition | S/m | Composition | S/m |
|---|---|---|---|
| RuO₂ | 3.55 × 10⁶ | NbO₂ | 3.82 × 10⁶ |
| MnO₂ | 1.95 × 10⁶ | WO₂ | 5.32 × 10⁶ |
| ReO₂ | 1.00 × 10⁷ | GaO₂ | 2.11 × 10⁶ |
| VO₂ | 3.07 × 10⁶ | MoO₂ | 4.42 × 10⁶ |
| OsO₂ | 6.70 × 10⁶ | InO₂ | 2.24 × 10⁶ |
| TaO₂ | 4.85 × 10⁶ | CrO₂ | 1.51 × 10⁶ |
| IrO₂ | 3.85 × 10⁶ | RhO₂ | 3.10 × 10⁶ |

The boride nano-sheet may be, for example, at least one selected from Ta₃B₄, Nb₃B₄, TaB, NbB, V₃B₄, and VB. In addition, the carbide nano-sheet may be, for example, at least one selected from Dy₂C and Ho₂C. The boride and carbide nano-sheets may be conductive nano-sheets having the conductivities shown in Table 2.

TABLE 2
Boride and carbide nano-sheets conductivity.

| Nano-sheet | Composition | σ (S/m) |
|---|---|---|
| Boride | Ta₃B₄ | 2,335,000 |
| | Nb₃B₄ | 3,402,000 |
| | TaB | 1,528,800 |
| | NbB | 5,425,100 |
| | V₃B₄ | 2,495,900 |
| | VB | 3,183,200 |
| Carbide | Dy₂C | 180,000 |
| | Ho₂C | 72,000 |

The chalcogenide nano-sheet may include, for example, at least one selected from AuTe₂, PdTe₂, PtTe₂, YTe₃, CuTe₂, NiTe₂, IrTe₂, PrTe₃, NdTe₃, SmTe₃, GdTe₃, TbTe₃, DyTe₃, HoTe₃, ErTe₃, CeTe₃, LaTe₃, TiSe₂, TiTe₂, ZrTe₂, HfTe₂, TaSe₂, TaTe₂, TiS₂, NbS₂, TaS₂, Hf₃Te₂, VSe₂, VTe₂, NbTe₂, LaTe₂, and CeTe₂. The chalcogenide nano-sheet may be a conductive nano-sheet having the conductivity as shown in Table 3 below.

TABLE 3
Chalcogenide nano-sheet conductivity.

| Composition | σ (S/m) | composition | σ (S/m) |
|---|---|---|---|
| AuTe₂ | 433,000 | TiSe₂ | 114,200 |
| PdTe₂ | 3,436,700 | TiTe₂ | 1,055,600 |
| PtTe₂ | 2,098,000 | ZrTe₂ | 350,500 |
| YTe₃ | 985,100 | HfTe₂ | 268,500 |
| CuTe₂ | 523,300 | TaSe₂ | 299,900 |
| NiTe₂ | 2,353,500 | TaTe₂ | 444,700 |
| IrTe₂ | 1,386,200 | TiS₂ | 72,300 |
| PrTe₃ | 669,000 | NbS₂ | 159,100 |
| NdTe₃ | 680,400 | TaS₂ | 81,000 |
| SmTe₃ | 917,900 | Hf3Te₂ | 962,400 |
| GdTe₃ | 731,700 | VSe₂ | 364,100 |
| TbTe₃ | 350,000 | VTe₂ | 238,000 |
| DyTe₃ | 844,700 | NbTe₂ | 600,200 |
| HoTe₃ | 842,000 | LaTe₂ | 116,000 |
| ErTe₃ | 980,100 | LaTe₃ | 354,600 |
| CeTe₃ | 729,800 | CeTe₂ | 55,200 |

The nano-sheet 44A may have a thickness in a range from about 1 nm to about 1,000 nm, or from about 5 nm to about 750 nm, or from about 10 nm to about 500 nm. The nano-sheet 44A may have a length in a range from about 0.1 μm to about 500 μm, or from about 0.5 μm to about 500 μm, or from about 1 μm to about 250 μm.

The conductive filler may include the nano-sheet 44A in an amount in a range from about 0.1 volume percent (vol %) to about 100 vol %, or in a range from about 5 vol % to about 90 vol %, or from about 10 vol % to about 80 vol %, based on a total volume of the conductive filler. The conductive filler may include the nano-sheet 44A in an amount of, for example, equal to or greater than 0.1 vol %, or equal to or greater than 5%, or equal to or greater than 10% and less than 100 vol %, or less than 90 vol %, or less than 80 vol %, based on a total volume of the conductive filler. In the heating layer 40 where the matrix 42 and the conductive filler 44 form a layer, an amount of the plurality of conductive fillers 44 in the layer may be less than an amount of the matrix 42 in the layer.

The metal particle 44B, which is a medium for reducing the contact resistance between two adjacent nano-sheets 44A, may include at least one metal selected from a noble metal, a transition metal, and a rare earth metal. The first and second metal particles may have a same composition as the metal particle 44B.

The noble metal may include at least one selected from Pd, Ag, Rh, Ru, Au, Pt, Ir, and Re. The transition metal may include one of Sc, Y, Ti, Zr, Hf, V, Nb, Ta, Cr, Mo, W, Mn, Fe, Co, Ni, Cu, and Zn. The rare earth metal may include at least one selected from La, Ce, Pr, Nd, Pm, Sm, Eu, Gd, Tb, Dy, Ho, Er, Tm, Yb, and Lu.

A size or a diameter of the metal particle 44B may be less than a size of the nano-sheet 44A. For example, the size or the diameter of the metal particle 44B may be in a range from about 1 nm to about 10 μm. In this case, the first and second metal particles may have the size or the diameter as the metal particle 44B.

### 2. Method of Manufacturing a Heating Element

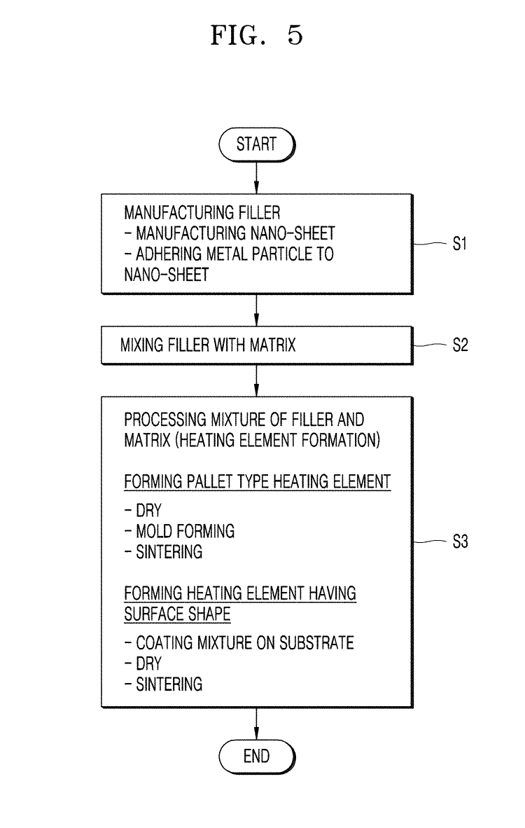

A method of manufacturing a heating layer and a heating element will be described with reference to FIG. 5, according to an example embodiment.

The method of manufacturing may be applicable for manufacturing, for example, a heating layer including conductive fillers in an amount of about 10 weight percent (wt %).

### 2.1 Manufacturing of a Conductive Filler Including Two Components (the Nano-Sheet and the Metal Particle (Operation S1).

### 2.1.1 Manufacturing of a Nano-Sheet.

As an example, a RuO₍₂₊ₓ₎ nano-sheet, where 0≦x≦0.1 may be manufactured. Other nano-sheets may be manufactured via applying same method used to form the RuO₍₂₊ₓ₎ nano-sheet, where 0≦x≦0.1.

In order to manufacture the RuO₍₂₊ₓ₎ nano-sheet, after mixing K₂CO₃ with RuO₂ at a molar ratio of about 5:8, the mixture may be in a cylindrical form, e.g., formed as pellets. The pellets may be placed in an aluminum crucible, and heat treated in a tube furnace at a temperature of about 850° C. for about 12 hours. The heat treatment may be performed under a nitrogen atmosphere. The weight of each of the pellets may be in a range from about 1 gram (g) to about 20 g. However, the weight of the pellets may vary as desired. The shape of the pellets may be, for example, a cylindrical shape, e.g., a disc shape.

After heat treatment of the pellets, when the temperature of the furnace is cooled down to room temperature, the alumina crucible may be taken out from the furnace and the pellets are ground to powder.

Next, after the powder has been washed with water in an amount of about 100 milliliter (mL) to about 4 L for about 24 hours, the powder may be separated by filtering the solution. At this point, the powder may have a composition of K_{0.2} RuO_{2.1}.nH₂O.

Next, the K_{0.2} RuO_{2.1}.nH₂O powder may be immersed in 1 molar (M) HCl solution and stirred for about 3 days. Afterwards, the powder may be recovered by filtering the solution. The composition of the powder obtained in this process may be H_{0.2} RuO_{2.1}.

Next, 1 gram (g) of the H_{0.2}RuO_{2.1} powder may be immersed in about 250 mL of an aqueous solution in which an intercalant such as tetramethylammonium hydroxide (TMAOH) and tetrabutylammonium hydroxide (TBAOH) are mixed, and the mixture may be stirred for more than 10 days. At this point, a concentration of the TMAOH and TBAOH may be approximately TMA+/H+, TBA+/H+=0.1˜50. After the stirring process is completed, the solution obtained after the stirring process is subjected to centrifugation, which may be performed via a centrifugal separator. The centrifugation may be performed at about 2,000 rpm for about 30 minutes. Through the centrifugation, an aqueous solution including exfoliated RuO₍₂₊ₓ₎ nano-sheets is separated from a precipitate including un-exfoliated powder.

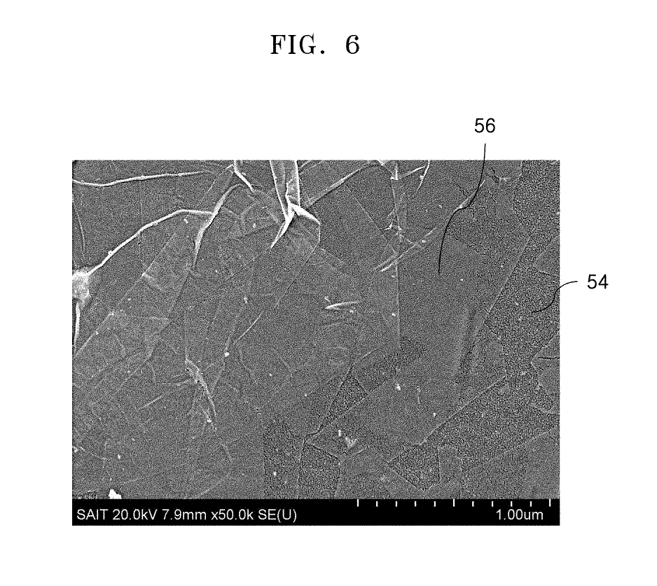

FIG. 6 shows a scanning electron microscope (SEM) photograph of an exfoliated RuO₍₂₊ₓ₎ nano-sheet, where 0≦x≦0.1. In FIG. 6, reference numerals 54 and 56 respectively denote a substrate and a RuO₍₂₊ₓ₎ nano-sheet.

The exfoliated RuO₍₂₊ₓ₎ nano sheets obtained by the centrifugation step may include RuO₂ nano-sheets (x=0) and RuO_{2.1} nano-sheets (x=0.1). For convenience sake, hereinafter, an RuO₍₂₊ₓ₎ nano-sheet is referred as an RuO₂ nano-sheet.

2.1.2 Absorption of a Metal Particle onto a Nano-Sheet (Manufacturing a Mixture of Two Components [a Conductive Filler])

The concentration of the aqueous solution including the exfoliated RuO₂ nano-sheet that is obtained through the centrifugation may be measured by using an Ultraviolet-Visible Spectrophotometer (UVS).

Next, an optical absorbency of the RuO₂ nano-sheet aqueous solution with respect a wavelength of about 350 nm may be measured, and the concentration (g/L) of the RuO₂ nano-sheet with respect to the RuO₂ nano-sheet aqueous solution may be calculated by using an absorbency coefficient (about 7,400 L/mol·cm) of the RuO₂ nano-sheet.

Next, a volume of the RuO₂ nano-sheet aqueous solution including a predetermined weight of the RuO₂ nano-sheet may be measured, and the measured RuO₂ nano-sheet aqueous solution may be put into a container (for example, a beaker).

Next, an about 25 millimolar (mmol) Pd(NO₃)₂ aqueous solution may be prepared in another beaker. Thereafter, a volume of the about 25 mmol Pd(NO₃)₂ aqueous solution may be measured such that a content of a metal particle (for example, Pd) is about 5 atomic percent (at %) to about 30 at % (for example about 10 at %) with respect to the RuO₂ nano-sheet, and the about 25 mmol Pd(NO₃)₂ aqueous solution may be put into the beaker containing the RuO₂ nano-sheet aqueous solution. After the RuO₂ nano-sheet aqueous solution and the Pd(NO₃)₂ aqueous solution have been mixed together, a resultant mixture may be stirred for a certain period of time, for example, for about 24 hours. As a result, a Pd-decorated RuO₂ nano-sheet (hereinafter, a “filler”) may be formed. Thereafter, a filler aqueous solution may be centrifuged by using the centrifugal separator and a solvent may be removed from the filler aqueous solution. The centrifuging may be performed at a speed greater than about 10,000 rpm for more than about 10 min, for example, for more than about 15 min.

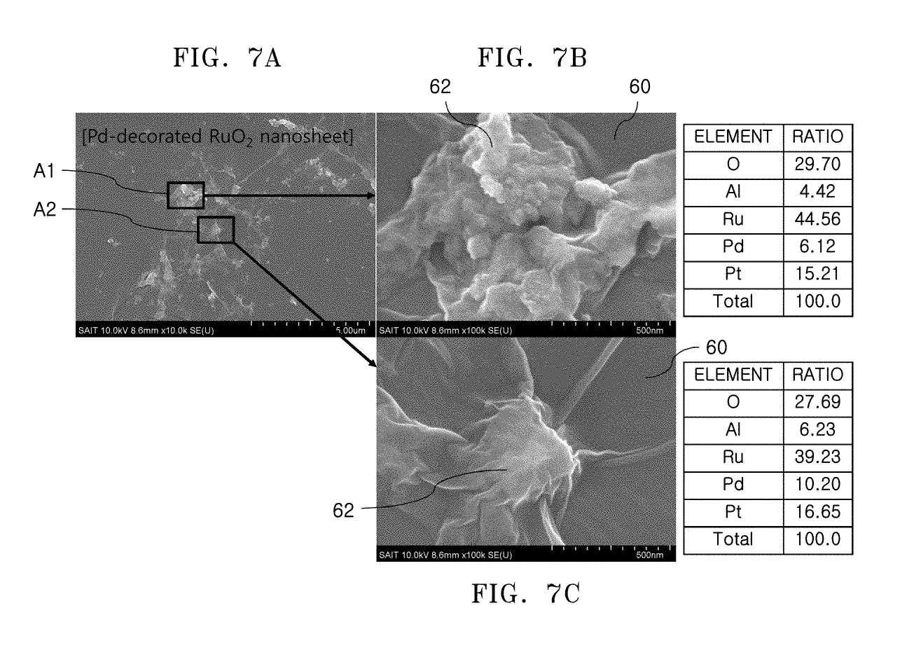

FIGS. 7A, 7B, and 7C are SEM photographs of the filler formed as previously presented.

FIG. 7A is an original photograph, and FIGS. 7B and 7C are respectively magnified photographs of a first region A1 and a second region A2 denoted in FIG. 7A. Reference numerals 60 and 62 respectively denote the nano-sheet and the Pd particles.

FIGS. 7A to 7C show that Pd particles 62 exist on the nano-sheet 60. That is, the aforementioned method of manufacturing formed fillers including two components.

An element composition table on a right side of FIG. 7 is a result obtained by an energy dispersion spectrometer (EDS) analysis on the formed fillers and shows that Pd has been detected. The results verify that the Pd particles have been decorated on the RuO₂ nanosheet. In the element composition table, Al composition denotes the Al composition of a substrate used for the SEM photograph measurement and the Pt composition denotes the Pt composition of a coating layer coated for providing conductivity to a sample measurement surface in the SEM photograph measurement.

### 2.2 Mixing of the Filler and the Matrix (Operation S2)

A predetermined amount of the matrix may be added to and mixed with an output from operation S1, wherein the solvent has been removed from the filler aqueous solution (i.e., the filler powder). The glass frit may be used as an example of the matrix. At this point, the matrix may be added to the output such that a weight percentage of the filler reaches a predetermined value (for example, 10 wt %). In a heating layer obtained after a mixture of the matrix and the filler has been processed, in order to ensure that a sufficient amount of the filler is used for establishing an electrical path such that electricity flows from an end to another end of the heating layer, an addition amount of the matrix may vary depending on a weight content of the RuO₂ nanosheet. The glass frit used as an example of the matrix may include at least one oxide selected from silicon oxide, lithium oxide, nickel oxide, cobalt oxide, boron oxide, potassium oxide, aluminum oxide, titanium oxide, manganese oxide, copper oxide, zirconium oxide, phosphorus oxide, zinc oxide, bismuth oxide, lead oxide, and sodium oxide. In an embodiment, the glass frit may be a silicon oxide having an additive added thereto, and the additive may include at least one selected from Li, Ni, Co, B, K, Al, Ti, Mn, Cu, Zr, P, Zn, Bi, Pb, and Na.

In the method of manufacturing a heating layer described above, the silicon oxide may be used as an example for the matrix.

Next, the filler and the matrix may be uniformly mixed by using, for example, a C-mixer to prepare the mixture.

### 2.3 Processing of the Mixture of the Filler and the Matrix (Forming a Heating Layer) (Operation S3)

### 2.3.1 Forming a Heating Layer Having a Pellet Shape

After the mixture including the filler and the matrix has been uniformly mixed using the C-mixer, the solvent may be removed. The solvent may be completely removed. The solvent may be completely removed by drying the mixture in an oven at a temperature of, for example, about 80° C. for about 24 hours. The mixture which has been dried in this manner may be put into a mold and formed into a pellet shape by applying pressure to the mold (a mold forming). Thereafter, the mixture formed into the pellet shape may be heated and sintered at about 500° C. to about 900° C. for about 1 min to about 20 min.

### 2.3.2 Forming a Heating Element Having a Surface Shape

After the mixture including the filler and the matrix has been uniformly mixed, the mixture may be formed on a substrate. A method of forming the mixture on the substrate may include, for example, coating the mixture on the substrate. The substrate may have a composition which is the same as or different from that of the matrix. The substrate may include a silicon substrate (e.g. a silicon wafer) or a metal substrate. When the substrate is a conductive substrate, a conductive layer may have been previously formed on the substrate before the mixture is formed on the substrate. The coating of the substrate with mixture may include a method selected from a screen printing method, an ink jet method, a dip coating method, a spin coating method, and a spray coating method.

Next, after the mixture has been formed on the substrate, the mixture formed on the substrate may be dried at about 100° C. to about 200° C. and the solvent may be removed from the mixture.

Next, an output having the solvent removed therefrom may be heat treated at about 500° C. to about 900° C. for about 1 min to about 20 min, for example, at about 600° C. for about 2 min. As a result, the mixture formed on the substrate may be sintered and the heating element having a sheet type may be formed on the substrate.

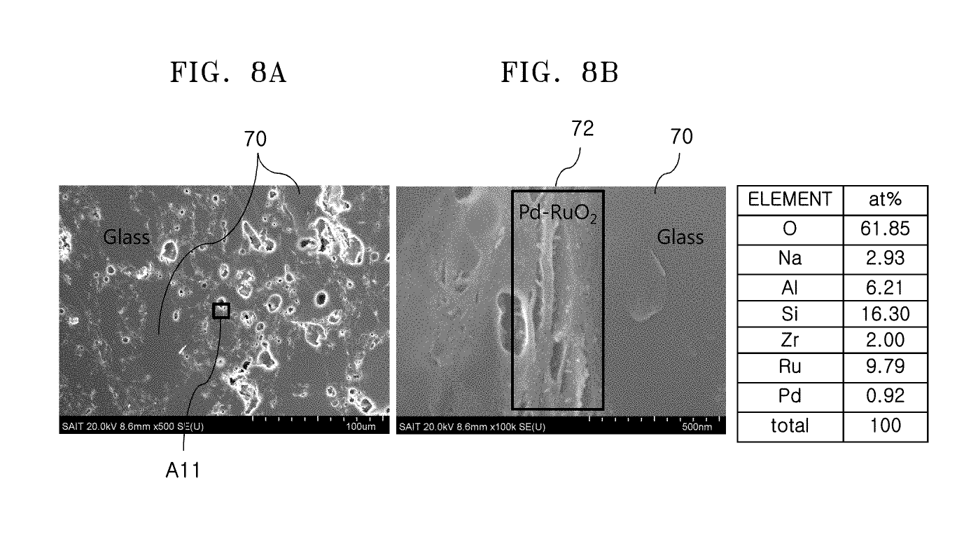

FIGS. 8A and 8B show a SEM photograph of a cross-section of the heating element formed in this manner.

FIG. 8A is an original photograph and FIG. 8B is an enlarged photograph of a first region A11 in FIG. 8A. Reference numeral 70 denotes a matrix and the solid-lined box 72 in FIG. 8B denotes the Pd-decorated nano-sheet.

In FIG. 8A, large and small regions that are distributed as islands around the matrix 70 denote the Pd-decorated nano-sheets, that is, the filler.

FIG. 8A shows that the fillers are, in general, uniformly distributed in the matrix 70. In addition, Pd and Ru have been detected as shown in the element composition table on a right side of FIG. 8, obtained via the EDS analysis. This result may indicate that the Pd-decorated RuO₂ nano-sheets are distributed in the heating element formed by the method of manufacturing described above.

The chalcogenide, boride, and carbide nano-sheets may be manufactured as described below.

Firstly, the chalcogenide nano-sheet may be manufactured as described below.

Element materials in a solid powder shape may be prepared. At this point, the element materials may be prepared by measuring weights of individual elements such that an atomic ratio is proper. Subsequently, the prepared element materials may be uniformly mixed and formed into a pellet shape. After pellets obtained in this manner have been put in a quartz tube, the quartz tube may be filled with Ar gas and sealed. The quartz tube containing the pellets may be put in the furnace and heat treated at about 500° C. to about 1300° C. for about 12 hours to about 72 hours. After the heat treatment, a heat treated product may be cooled down to an ambient temperature, and the pellets in the quartz tube may be taken out and ground to powder.

Next, Li ions may be injected into between chalcogenide layers in a powder shape. The Li ions may be injected between the chalcogenide layers in the powder shape by using a Li ion source, for example, n-butyl lithium.

According to another example embodiment, the Li ions may be injected between the chalcogenide layers in the powder shape via an electrical-chemical method, instead of using the Li ion source.

When the Li ions are injected between the chalcogenide layers in the powder shape, gaps between the chalcogenide layers may become wider and thus, the chalcogenide layers, that is, the chalcogenide nano-sheets may be easily exfoliated. When the Li ions are substituted by larger molecules (for example, water molecules or organic molecules), the gaps between the chalcogenide layers may be further widened. Accordingly, the chalcogenide nano-sheets may be more easily exfoliated.

Another method of enhancing the exfoliation of the chalcogenide nano-sheets may be a method wherein, after the Li ions have been injected between the chalcogenide layers in the powder shape, an ultrasonication may be applied to the chalcogenide.

Thereafter, a process of attaching the metal particles to the exfoliated nano-sheet and a process of forming a heating element may proceed as previously described with respect to the process of attaching the metal particles to the RuO₂ nano-sheet and the process of forming the heating element.

The boride nano-sheet may be manufactured using at least two different methods as described below.

A first method may be the same as the above-described method of manufacturing the chalcogenide nano-sheet.

A second method will be described below.

Element materials in a solid powder shape may be prepared. At this point, the element materials may be prepared by measuring weights of individual elements such that an atomic ratio is proper. Subsequently, the prepared element materials may be uniformly mixed and formed into a pellet shape. After the pellets obtained in this manner have been placed in an arc melting device, the pellets may be melted by using an arc. The process of applying the arc may be repeated several times until the pellets are uniformly melted and form a single uniform phase. Thereafter, a product may be cooled down to the ambient temperature, and the product may be taken out from the arc melting device and ground to powder. Thereafter, Li ions may be injected between chalcogenide layers in the powder shape. The Li ions may be injected between boride layers in the powder shape using a Li ion source, for example, n-butyl lithium. Instead of the Li ion source, the Li ions may be injected between the boride layers in the powder shape via an electrical-chemical method. When the Li ions are injected between the boride layers in the powder shape, gaps between the boride layers may become wider and thus, the boride layer, that is, the boride nano-sheet, may be easily exfoliated. When the Li ions are substituted by larger molecules (for example, a water molecule or an organic molecule), the gaps between the boride layers may be further widened. Accordingly, the boride nano-sheet may be more easily exfoliated.

After the Li ions have been injected between the boride layers in the powder shape, the boride nano-sheet may be exfoliated via ultrasonication of the boride.

Thereafter, a process of attaching the metal particles to the exfoliated nano-sheet and a process of forming a heating element may proceed as previously described with regard to the process of attaching the metal particles to the RuO₂ nano-sheet and the process of forming the heating element.

The carbide nano-sheet may be manufactured according to the method of manufacturing the boride nano-sheet described above.

### 3. Measurement of Electrical Conductivity

An electrode may be formed by pasting Ag paste onto both ends of the formed heating element and drying the Ag paste. Resistance between the two electrodes may be measured, and a width, a height, and a thickness of the heating element may be measured, and then, the electrical conductivity of the heating element may be determined.

4. Comparison of an Example Heating Element with a Comparative Heating Element

An example heating element (hereinafter, a first heating element) and the comparative heating element (hereinafter, a second heating element) may be manufactured and compared with each other.

The first heating element is formed via the method of manufacturing described above. The first heating element includes the Pd-decorated RuO₂ nano-sheet as the filler, and includes the glass fit as the matrix. In the first heating element, a ratio of the Pd particles to the RuO₂ nano-sheets (Pd/RuO₂) may be about 10 at % and a ratio of the RuO₂ nano-sheets to the glass frits (RuO₂/glass) may be about 4 vol %.

The second heating element does not include metal particles, but includes a filler including only the RuO₂ nano-sheet and the glass frit. In the second heating element, the ratio of the RuO₂ nano-sheets to the glass frits (RuO₂/glass) may be in a range of about 4 vol %, which is the same as that of the first heating element.

In order to compare heating characteristics of the first and second heating elements, the electrical conductivities thereof have been measured, and the results are summarized in Table 4.

TABLE 4
Measurement result of the electrical conductivity
of the first and second heating elements.

| | Electrical |
|---|---|
| Heating Element | Conductivity (S/m) |
| First heating element | 578 |
| (10 at % Pd—RuO₂/glass) | |
| Second heating element | 292 |
| (RuO₂/glass) | |

Referring to Table 4, the electrical conductivity (578 S/m) of the example heating element of the i.e., the first heating element, is nearly two times greater than the electrical conductivity (292 S/m) of the second heating element.

A difference in the electrical conductivity between the first and second heating elements may be related to whether the metal particles are present on the RuO₂ nano-sheet. Without being limited by theory, it is believed that the results in Table 4 may indicate that the presence of the metal particles (Pd) between the RuO₂ nano-sheets in the first heating element reduces the contact resistance between the RuO₂ nano-sheets.

### 5. An Apparatus Including a Heating Element

Since the heating element described herein is useful as a source for generating heat, the heating element may be included in an apparatus in need of a heating source and may be used as a heating part of an electronic device. For example, the heating element may be applied to a printer, for example, as a fuser of the printer. In addition, the heating element may be applied in a thin film resistor or a thick film resistor.

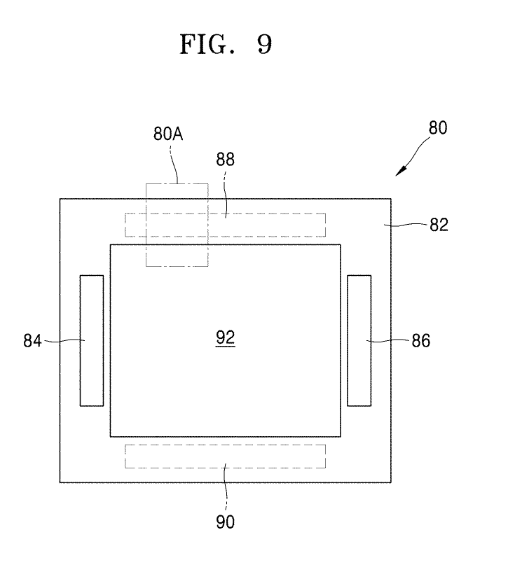

FIG. 9 shows an example of an apparatus 80 including a first heating element 84 as a heating source, according to an example embodiment.

Referring to FIG. 9, the apparatus 80 may include a body 82 and the first heating element 84 included in the body 82. The apparatus 80 may be an electrical apparatus or an electronic apparatus. For example, the apparatus 80 may be an oven. The body 82 of the apparatus 80 may include an inner space 92 accommodating an object therein. When the apparatus 80 is operated, energy (for example, heat) may be supplied to warm up the object contained in the inner space 92 or to increase the temperature of the inner space 92. The first heating element 84 included in the body 82 of the apparatus 80 may be placed such that generated heat is emitted toward the inner space 92. The first heating element 84 may be the exemplary heating element of described above with reference to FIGS. 1 through 4 and may be the heating element manufactured according to the method of manufacturing exemplified in FIG. 5. A second heating element 86 may be included in the body 82. The second heating element 86 may face the first heating element 84 and a heat-emitting surface thereof may face the inner space 92. The second heating element 86 may be the exemplary heating element described above with reference to FIGS. 1 through 4 and may be the heating element manufactured according to the method of manufacturing exemplified in FIG. 5. The first and second heating elements 84 and 86 may be same or different from each other. In addition, as illustrated by the dotted lines, a third heating element 88 and a fourth heating element 90 may be further included in the body 82. Alternatively, in one embodiment, only one of the third and fourth heating elements 88 and 90 may be included. In another embodiment, only the third and fourth heating elements 88 and 90 may be included in the body 82. In the body 82, at least one of an adiabatic member (not shown) and a thermal reflection member (not shown) may be placed on external boundary surfaces of the body 82 and between respective pairs of the heating elements 84, 86, 88, and 90.

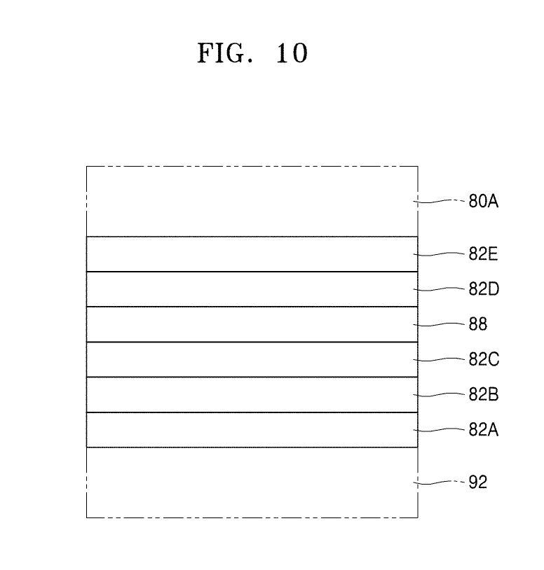

FIG. 10 shows an enlarged cross-section of a portion of the apparatus shown in FIG. 9, and which is designated as a first region 80A.

Referring to FIG. 10, in the body 82, an insulator 82D and a case 82E may be sequentially placed in an upward direction from the third heating element 88, that is, between the third heating element 88 and an external region. The case 82E may be a case on the outside of the apparatus 80. The insulator 82D between the case 82E and the third heating element 88 may extend to other regions where other heating elements 84, 86, and 90 are placed in the body 82. The insulator 82D may be positioned such that heat emitted from the third heating element 88 may be blocked from escaping to the outside of the apparatus 80.

A second insulating layer 82C, a substrate 82B, and a first insulating layer 82A may be placed in a downward direction from the third heating element 88, that is, between the third heating element 88 and an inner space 92. The first insulating layer 82A, the substrate 82B, the second insulating layer 82C, and the third heating element 88 may be sequentially stacked from the inner space 92 toward the outside of the apparatus 80. The aforementioned layer composition may be applicable to regions where the first, second, and fourth heating elements 84, 86, and 90 are placed.

The first and second insulating layers 82A and 82C may be formed of an identical insulating material or different insulating materials from each other. At least one of the first and second insulating layers 82A and 82C may be an enamel layer, however the embodiment is not limited thereto. The thickness of the insulating layers 82A and 82C may be identical or different from each other. The substrate 82B may be a supporting member for maintaining the structure of the body 82 of the apparatus 80 while supporting the first through fourth heating elements 84, 86, 88, and 90. The substrate 82B may be, for example, a metal substrate. However, the example embodiment is not limited thereto.

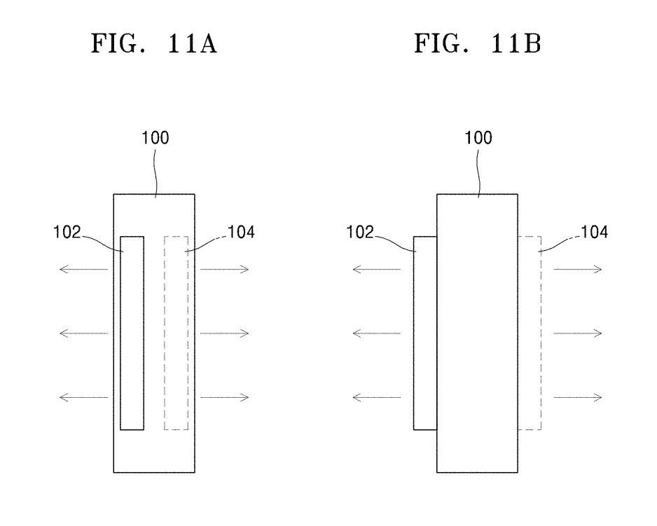

FIG. 11A shows an apparatus including a heating element according to another embodiment.

Referring to FIG. 11A, a first apparatus 102 may be inside a wall 100. The first apparatus 102 may be a heating element configured to emit heat toward the outer side of a first surface (the outside) of the wall 100. When the wall 100 is at least one of the walls defining a room, the first apparatus 102 may be a heat generation apparatus that discharges heat to increase a temperature of the room or to warm up the room. As illustrated in FIG. 11B, the first apparatus 102 may be installed on an outer surface of the wall 100.

Even though not illustrated, the first apparatus 102 may also be separate from the wall 100. When the first apparatus 102 is separate from the wall 100, the first apparatus 102 may be a unit capable of independent movement. Accordingly, the first apparatus 102 may be moved by a user to a desired location within the room.

The first apparatus 102 may include a heating element (not shown) therein for emitting heat. The heating element may be the heating element as described herein with reference to FIGS. 1 through 4 and the heating element may be manufactured according to the method of manufacturing described herein with reference to FIG. 5. An entire structure of the first apparatus 102 may be embedded inside the wall 100, but a panel for controlling the first apparatus 102 may be on the surface of the wall 100.

A second apparatus 104 may be inside the wall 100. The second apparatus 104 may be a heat generation apparatus configured to discharge heat toward an outer side (e.g. external to) a second surface of the wall 100. If the wall 100 is at least one of walls that define a room, the second apparatus 104 may be an apparatus that discharges heat to heat up an adjacent room or another region neighboring the room with the wall 100 therebetween. As illustrated in FIG. 11B, the second apparatus 104 may be installed on a surface of the wall 100. Even though not illustrated, the second apparatus 104, as the first apparatus 102, may also be independently operated while being separate from the wall 100. The second surface may be a surface opposite to the first surface or a surface facing the first surface. The second apparatus 104 may include a heating element (not shown) that generates heat. The heating element may be a heating source for increasing a temperature on an outside of (e.g. external to) the second surface of the wall 100. At this point, the heating element may be the heating element described herein with reference to FIGS. 1 through 3 and the heating element manufactured according to the method described herein with reference to FIG. 4. Most parts of the second apparatus 104 may be embedded inside the wall 100, but a panel for controlling the second apparatus 104 may be on a surface of the wall 100.

Arrows in FIGS. 11A and 11B denote heat emitted from the first and second apparatuses 102 and 104.

The first apparatus 102 and the second apparatus 104 may respectively have detachable structures. In this case, the first apparatus 102 and the second apparatus 104 may be installed inside a window. For example, when the reference numeral 100 in FIG. 11B denotes not a wall but a window, the first apparatus 102 may be a heating element installed inside the window 100. In this case, the second apparatus 104 may not be needed. When the first apparatus 102 is installed on the wall, the first apparatus 102 may be installed on an entire inner surface of the wall, or alternatively, may be installed only on a portion of an inner surface of the wall.

In another embodiment, the heating element may be included in a means or an apparatus for providing a personal source of warmth to a user. For example, the heating element may be included in a hot pack, a garment which the user puts on the user's body (for example, a jacket or a vest), gloves, boots, etc. In this case, the heating element may be included inside the garment or on an inner surface of the garment.

In another example embodiment, the heating element may be included in a wearable device. In addition, the heating element may be included in an outdoor apparatus designed to emit heat in a cold environment.

The heating element may include the conductive filler including the nano-sheets and the metal particles. The metal particles may be in contact with of the nano-sheets. Accordingly, the metal particles may exist between adjacent nano-sheets in at least a section of the electrical path which is formed by the nano-sheets. Without being limited by theory, it is believed that when the metal particles are direct contact with adjacent nano-sheets, the contact resistance between adjacent nano-sheets may decrease, and thus, the electrical conductivity in at least a section of the electrical path may be greater than when only nano-sheets are used as the conductive filler. The metal particles may also be present between the nano-sheets throughout the electrical path. Accordingly, the electrical conductivity along the entire electrical path may be greater than when only the nano-sheets are present, and as a result, the heating characteristics of the heating element may be better than when only nano-sheets are used as the conductive filler.

In addition, since the nano-sheets including the disclosed nano-materials are included in the conductive filler, the formation of a percolation network may more easily occur as compared to a filler which does not include the nano-sheets (i.e., a filler including only the metal particles).

In addition, since the conductive filler includes the nano-sheets including the disclosed nano-materials, a smaller amount of the conductive filler may be used to cover the surface of the matrix as compared to a filler which does not include the nano-sheets. Accordingly, when similar amounts of the filler without the nano-sheets are compared to the conductive filler, the electrical conductivity of the heating element of the present disclosure may be much greater than that of the filler without the nano-sheets.

In addition, in the case of the heating element of the present disclosure, since the electrical conductivity of the electrical path is much greater, the sinterability of the heating element may be improved and the sintering temperature may be reduced. Thus, the method of manufacturing the heating element of the present disclosure may be processed at a relatively lower temperature and accordingly, the processability may also be improved.

Since the heating element has improved heating characteristics, when the heating element is used in a heating apparatus, an electrical apparatus, or an electronic apparatus, the heating characteristics and/or operational characteristics of the corresponding apparatus may be improved.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A heating element comprising:
a matrix; and
a plurality of conductive fillers,
wherein some of the plurality of conductive fillers include first nano-sheets and first metal media configured to reduce a contact resistance between the first nano-sheets.

2. The heating element of claim 1, wherein others of the plurality of conductive fillers comprise second nano-sheets and second media configured to reduce a contact resistance between the second nano-sheets.

3. The heating element of claim 2, wherein the first nano-sheets and the second nano-sheets are the same as or different from each other, and
wherein the first metal media and the second metal media are same as or different from each other.

4. The heating element of claim 2, wherein the first nano-sheet comprises at least one nano-sheet selected from an oxide nano-sheet, a boride nano-sheet, a carbide nano-sheet, and a chalcogenide nano-sheet, and
wherein the second nano-sheet is the same as or different from the first nano-sheet.

5. The heating element of claim 2, wherein the first metal medium is a first metal particle comprising at least one selected from a noble metal, a transition metal, and a rare earth metal, and the second metal medium is a second metal particle which is same as or different from the first metal particle.

6. The heating element of claim 5, wherein a diameter of the first metal particle and a diameter of the second metal particle are each independently about 1 nanometer to about 10 micrometers.

7. The heating element of claim 1, wherein others of the plurality of conductive fillers comprise only the first nano-sheets or only second nano-sheets which are different nano-sheets from the first nano-sheets.

8. The heating element of claim 1, wherein the matrix and the plurality of conductive fillers are in a form of a layer, and an amount of the plurality of conductive fillers in the layer is less than an amount of the matrix in the layer.

9. The heating element of claim 8, wherein the plurality of conductive fillers comprises the nano-sheet in an amount equal to or greater than about 0.1 volume percent and less than 100 volume percent, based on a total volume of the plurality of conductive fillers.

10. The heating element of claim 8, wherein the plurality of conductive fillers are distributed from an end of the layer to another end of the layer and is configured to form an electrical path through the layer.

11. The heating element of claim 8, wherein the layer is disposed on a substrate and the substrate is an insulating substrate.

12. The heating element of claim 8,
wherein a heating layer comprises the matrix and the plurality of conductive fillers,
wherein the heating element further comprises a substrate disposed on the heating layer,
wherein the substrate is a conductive substrate, and
wherein an insulating layer is disposed between the substrate and the heating layer.

13. The heating element of claim 10, wherein a portion of the electrical path comprises the first nano-sheet and the first metal media.

14. The heating element of claim 13, wherein another portion of the electrical path comprises the first nano-sheets, a second nano-sheets, or the second nano-sheets and a second metal media, which is in contact with the second nano-sheets and which is configured to reduce a contact resistance of the second nano-sheets.

15. The heating element of claim 14, wherein the first nano-sheets and the second nano-sheets are same as or different from each other.

16. The heating element of claim 14, wherein the first metal medium and the second metal medium are same as or different from each other.

17. The heating element of claim 1, wherein the heating layer has a cylindrical shape or a film shape.

18. The heating element of claim 1, wherein the first metal medium is in contact with at least one surface of the first nano-sheet.

19. The heating element of claim 1, wherein the first nano-sheet comprises a first oxide nano-sheet, or wherein the first nano-sheet comprises the first oxide nano-sheet and a second oxide nano-sheet, wherein the first and second oxide nanosheets are different from each other.

20. The heating element of claim 1, wherein the matrix comprises a glass frit or an organic material.

21. The heating element of claim 20, wherein the glass frit comprises at least one selected from silicon oxide, lithium oxide, nickel oxide, cobalt oxide, boron oxide, potassium oxide, aluminum oxide, titanium oxide, manganese oxide, copper oxide, zirconium oxide, phosphorus oxide, zinc oxide, bismuth oxide, lead oxide, and sodium oxide.

22. The heating element of claim 20,
wherein the glass frit comprises silicon oxide and an additive, and
wherein the additive comprises at least one selected from Li, Ni, Co, B, K, Al, Ti, Mn, Cu, Zr, P, Zn, Bi, Pb, and Na.

23. The heating element of claim 20, wherein the organic material comprises at least one selected from polyimide, polyphenylenesulfide, polybutylene terephthalate, polyamideimide, liquid crystalline polymer, polyethylene terephthalate, and polyetheretherketone.

24. A method of manufacturing a heating element, comprising:
mixing a plurality of conductive filler and a matrix to form a mixture;
forming a product having a predetermined shape from the mixture; and
heat treating the product to provide the heating element,
wherein the plurality of conductive fillers comprises a first nano-sheet and a first metal, and
wherein the first metal is in contact with the first nano-sheet.

25. The method of claim 24, wherein the forming of the product comprises coating a substrate with the mixture and drying the coating on the substrate.

26. The method of claim 25, wherein the substrate is selected from a substrate having a same composition as the matrix, a silicon substrate, and a metal substrate.

27. The method of claim 25, wherein the coating of the substrate with the mixture comprises a method selected from a screen printing method, an ink jet method, a dip coating method, a spin coating method, and a spray coating method.

28. The method of claim 24, wherein the matrix material comprises a glass frit.

29. An apparatus comprising the heating element of claim 1.

30. The apparatus of claim 29, further comprising at least one selected from an adiabatic member and a thermal reflection member, which is disposed on a side of the heating element.

31. The apparatus of claim 29, wherein the heating element is disposed to supply heat to a region inside the apparatus.

32. The apparatus of claim 29, wherein the heating element is disposed to supply heat to a region on an outside of the apparatus.
